(19) United States
(12) Patent Application Publication
(10) Pub. No.: US 2002/0191944 A1
(43) Pub. Date: Dec. 19, 2002

(54) Microlamp

(76) Inventors: David Frank Moore, Cambridge (GB); Richard Rodney Anthony Syms, London (GB)

Correspondence Address: Carol W Burton, Hogan & Hartson, One Tabor Center Suite 1500, 1200 Seventeenth Street, Denver, CO, 80202, US

(21) Appl. No.: 10/149,886

(22) PCT Filed: Dec. 14, 2000
(86) PCT No.: PCT/GB00/04804

(30) Foreign Application Priority Data
Dec. 15, 1999 (GB) 9929668.3

(51) Int. Cl. G02B 6/00

(52) U.S. Cl. 385/137; 385/136

(57) ABSTRACT

A microlamp for holding a micropart in a desired position comprising a substrate (12) having an upper surface and a lower surface, and defining a throughhole (20) extending from the upper surface to the lower surface to have an upper opening and a lower opening; at least one first holding element (11, 15) secured to the substrate and provided at the upper end of the throughhole; and at least one second holding element (13, 14) secured to the substrate and provided at the lower end of the throughhole; the first and second holding elements arranged such that when, in use, the micropart is inserted into the throughhole it is held at least partially by the first and second holding elements such that it is located in the desired position along at least one direction perpendicular to the longitudinal axis of the hole.

The present invention relates to microclamps for holding microcomponents, and to a method of producing such microclamps, particularly for application in optics and electronics.

In microsystems technology (MST) and Microelectromechanical systems (MEMS) there is often a need for engineers to assemble components in precise locations with respect to each other. The cost of assembly is a significant part of the cost of the complete microsystem, and it is therefore advantageous to simplify and automate the assembly procedure.

In silicon technology, for example, the precise location of optical fibres is typically achieved by etching V-shaped grooves in the silicon substrate by anisotropic etching with selective alkaline liquids. A fibre is placed and glued in position in a V-shaped groove where the sides are the (111) related directions in the silicon. In more advanced systems the mechanical properties of thin films of materials such as silicon nitride on silicon are utilized to provide a force to hold the optic fibre against the silicon (111) face and kinematic location in the V-shaped groove. Silicon clips made by selective etching of p-n junctions with ultra violet illumination providing the selectivity have also been demonstrated to hold a silicon chip inside a recess in a silicon wafer. Reference is made in this respect to J. Micromech. Microeng. 8(1998) 39-44.

According to a first aspect of the present invention there is provided a microclamp for holding a micropart in a desired position comprising a substrate having an upper surface and a lower surface, and defining a throughhole extending from the upper surface to the lower surface to have an upper opening and a lower opening; at least one first holding element secured to the substrate and provided at the upper end of the throughhole: and at least one second holding element secured to the substrate and provided at the lower end of the throughhole: the first and second holding elements arranged such that when, in use, the micropart is inserted into the throughhole it is held at least partially by the first and second holding elements such that it is located in the desired position along at least one direction perpendicular to the longitudinal axis of the hole.

According to a preferred embodiment of the present invention, there is provided a microclamp for holding a micropart comprising a substrate having an upper surface and a lower surface, and defining a throughhole extending from the upper surface to the lower surface to have an upper opening and a lower opening; at least one first flexible holding element formed on the upper surface of the substrate and extending partially over the upper opening of the throughhole; and at least one second flexible holding element formed on the lower surface and extending partially over the lower opening of the throughhole; each flexible holding element being flexible in a direction parallel to the longitudinal axis of the hole.

According to a second aspect of the present invention there is provided a composite structure comprising a microclamp according to the present invention and a micropart inserted and held in the throughhole.

According to a third aspect of the present invention, there is provided a multi-clamping structure for holding a plurality of microparts comprising a first microclamp according to the present invention, and a second microclamp according to the present invention, wherein the first and second microclamps are connected together.

According to a fourth aspect of the present invention, there is provided a method of producing a microclamp comprising the steps of: providing a substrate having an upper surface and a lower surface; forming a first layer of a micromechanically flexible material on the upper surface of the substrate; forming a second layer of a micromechanically flexible material on the lower surface of the substrate; selectively removing a portion of the first layer of micromechanically flexible material, the substrate, and the second layer of micromechanically flexible material to form therein first, second and third throughholes, respectively, the first, second and third throughholes lying on a common axis; and then further removing a portion of the substrate lying between the first and second layers of micromechanically flexible material to increase the size of the second throughhole formed in the substrate, and thereby leave one or more portions of the first and second layers of micromechanically flexible material extending partially over the upper and lower openings of the enlarged second throughhole, respectively, to serve as flexible holding elements.

Embodiments of the present invention are described hereunder, by way of example only, with reference to the accompanying drawings in which:

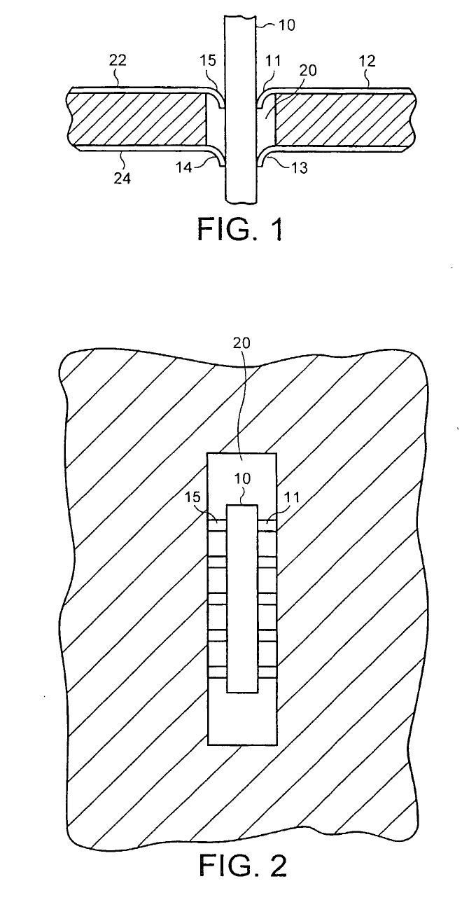

FIG. 1 shows a schematic cross-sectional view of a microcomponent held by a microclamp according to a first embodiment of the present invention;

FIG. 2 shows a schematic plan view of a microcomponent held by a microclamp according to the first embodiment of the present invention;

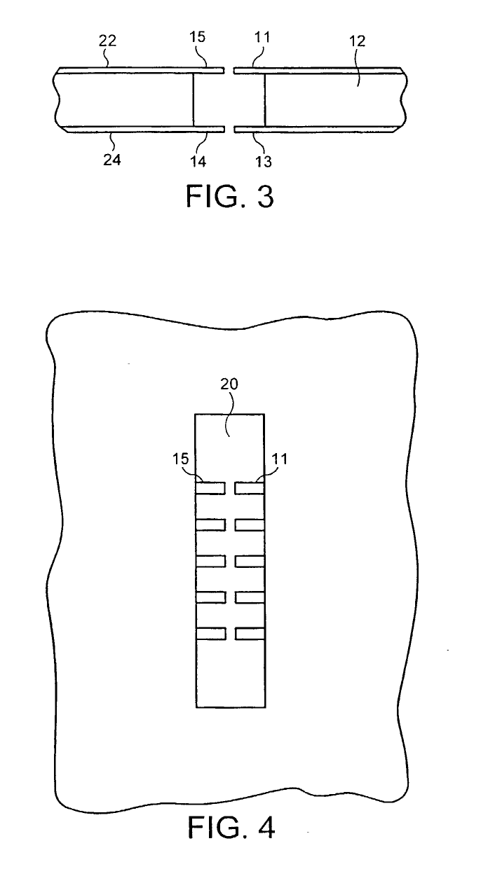

FIG. 3 shows a schematic cross-sectional view of a microclamp according to the first embodiment of the present invention;

FIG. 4 shows a schematic plan view of a microclamp according to the first embodiment of the present invention;

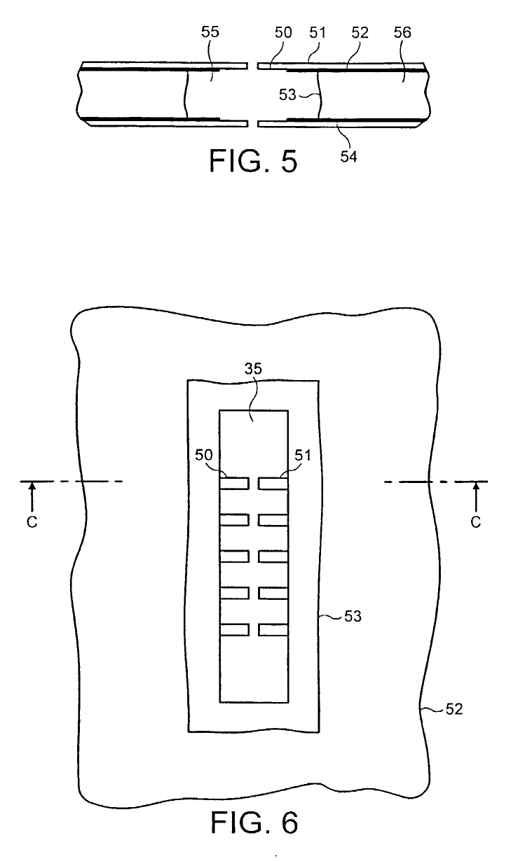

FIG. 5 shows a schematic cross-sectional view of a microclamp according to a second embodiment of the present invention;

FIG. 6 shows a schematic plan view of a microclamp according to the second embodiment of the present invention;

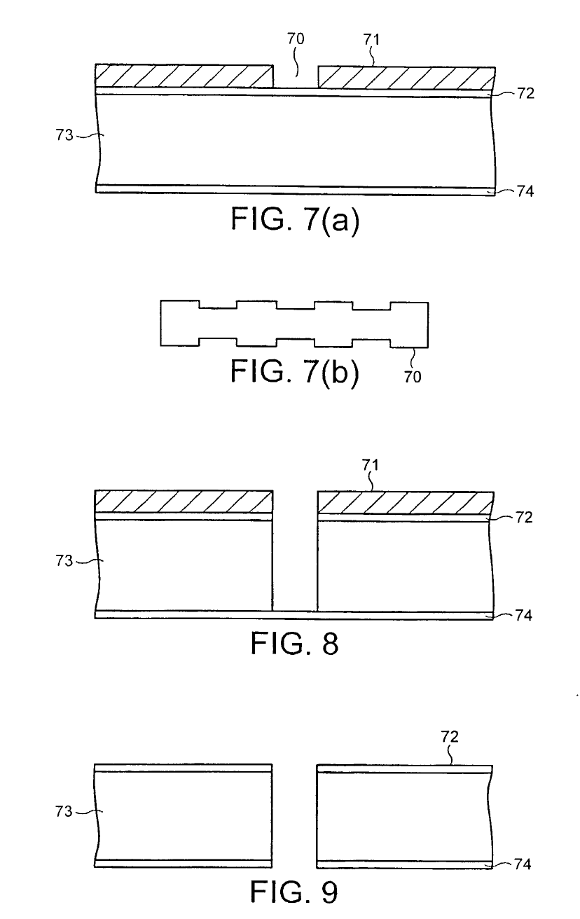

FIGS. 7 to 11 are schematic cross-sectional views showing the stages of production of a microclamp according to an embodiment of the present invention to explain a method of producing a microclamp according to the method of the present invention;

FIG. 12 show a schematic plan view of the microclamp produced by the method shown in FIGS. 7 to 11;

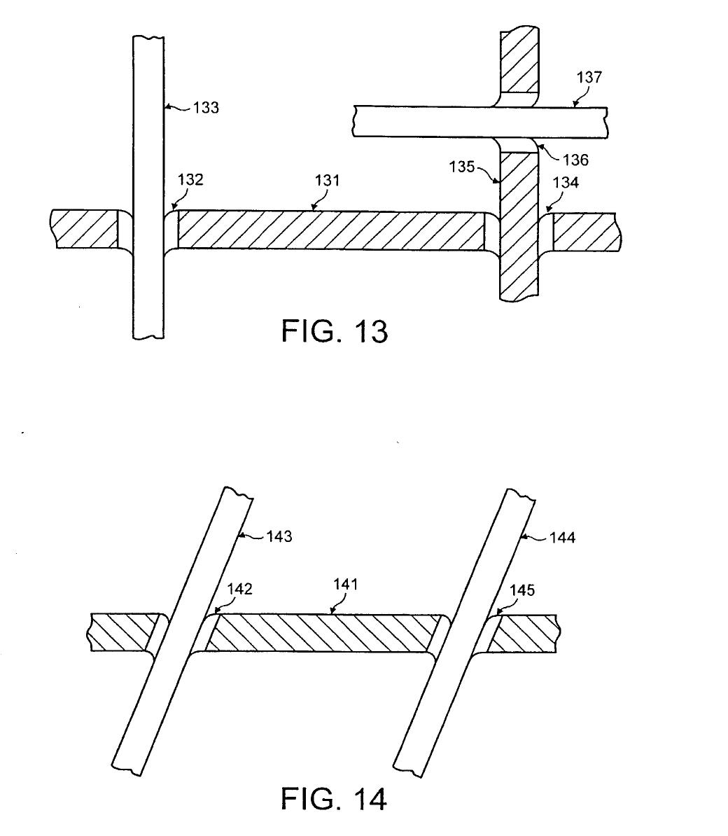

FIG. 13 shows a schematic cross-sectional view of a plurality of microcomponents clamped to each other via a plurality of microclamps according to an embodiment of the present invention;

FIG. 14 shows a schematic cross-sectional view of a multi-clamping structure according to an embodiment of the present invention with two microparts held at an oblique angle to the plane of the substrate;

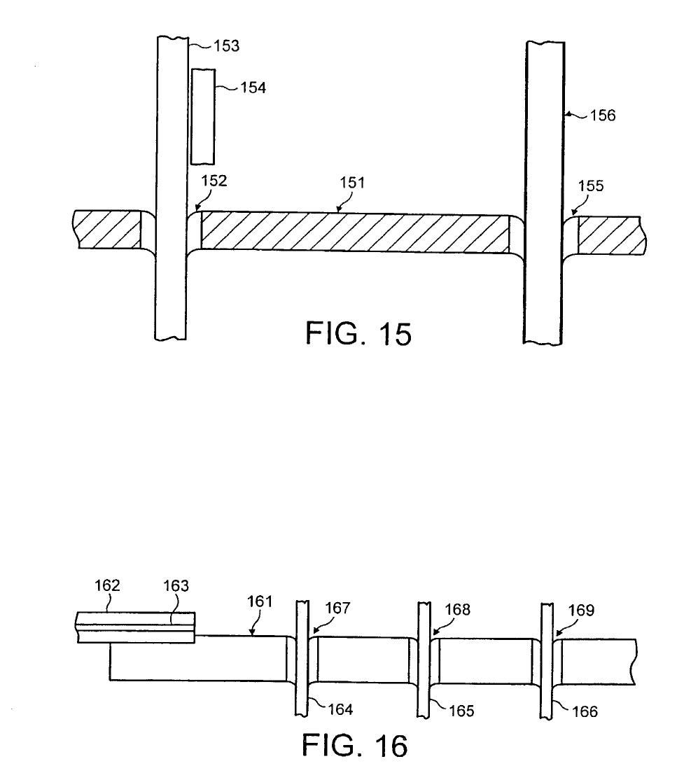

FIG. 15 shows a schematic cross-sectional view of a multi-clamping structure according to an embodiment of the present invention with two dissimilar composite microparts clamped to a common substrate;

FIG. 16 shows a schematic cross-sectional view of a multi-clamping structure according to an embodiment of the present invention with a plurality of optical microparts clamped to a common substrate and aligned to an optic fibre;

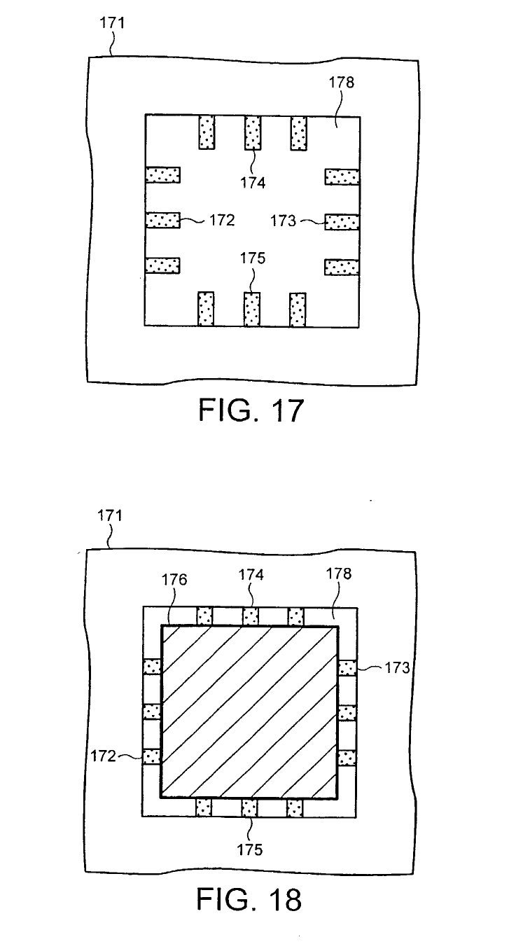

FIG. 17 shows a schematic plan view of a microclamp according to another embodiment of the present invention;

FIG. 18 shows a schematic cross-sectional view of the microclamp shown in FIG. 17 holding a component with a square cross-section:

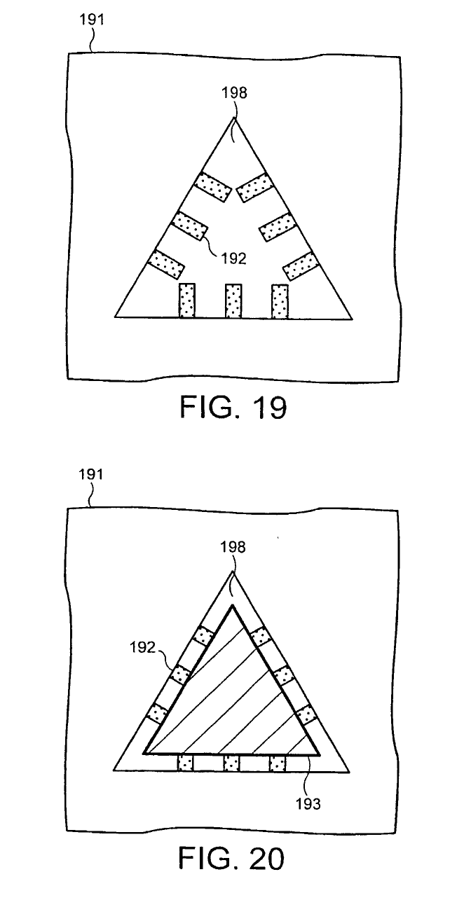

FIG. 19 shows a schematic plan view of a microclamp according to another embodiment of the present invention;

FIG. 20 shows a schematic cross-sectional view of the microclamp shown in FIG. 19 holding a component with a triangular cross section;.

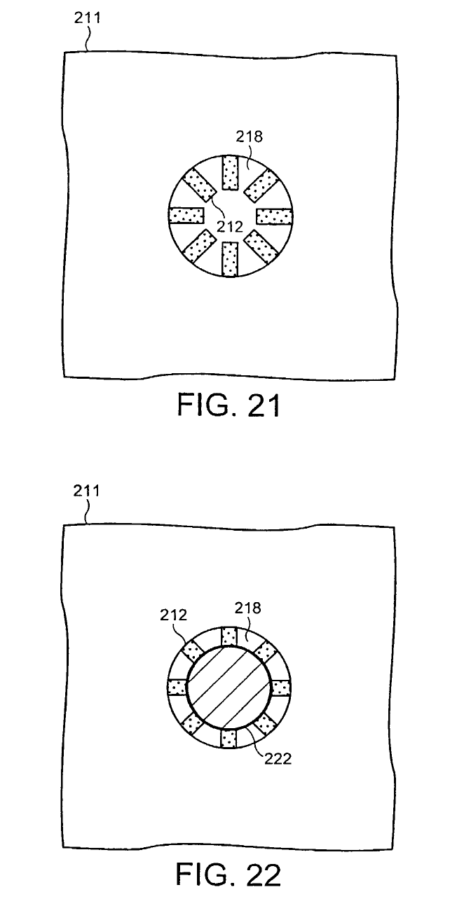

FIG. 21 shows a schematic plan view of a microclamp according to another embodiment of the present invention.

FIG. 22 shows a schematic cross-sectional view of the microclamp shown in FIG. 21 holding a component with a cylindrical cross section;

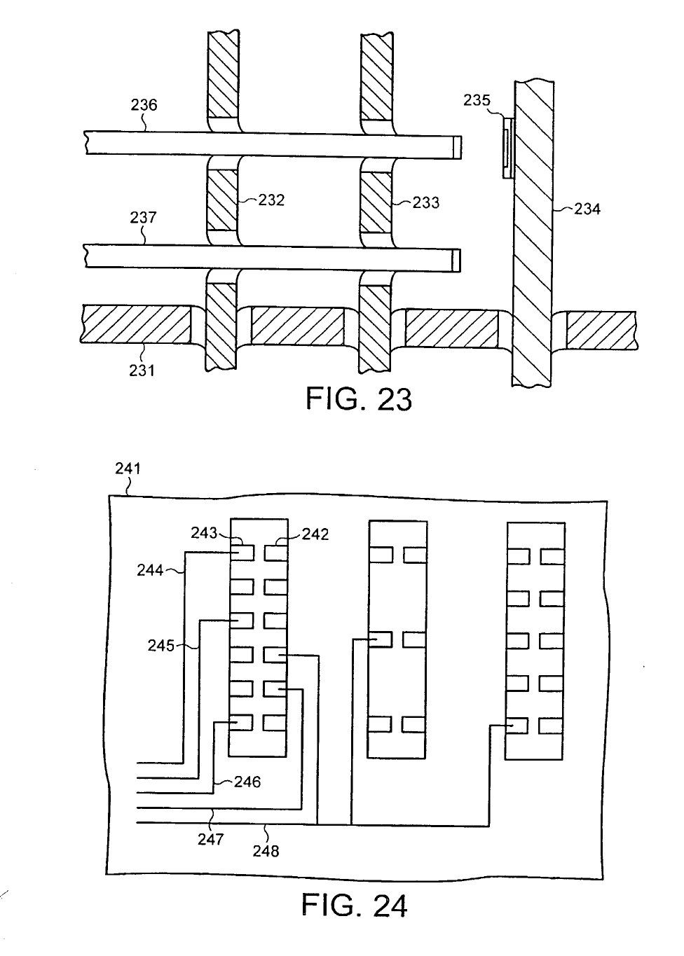

FIG. 23 shows a schematic cross-sectional view of a composite structure according to an embodiment of the present invention comprising a plurality of microparts including a plurality of optic fibres clamped to a common substrate via a plurality of microclamps according to an embodiment of the present invention;

FIG. 24 shows a schematic plan view of a multiclamping structure according to an embodiment of the present invention provided with electrical connections to a plurality of the holding elements;

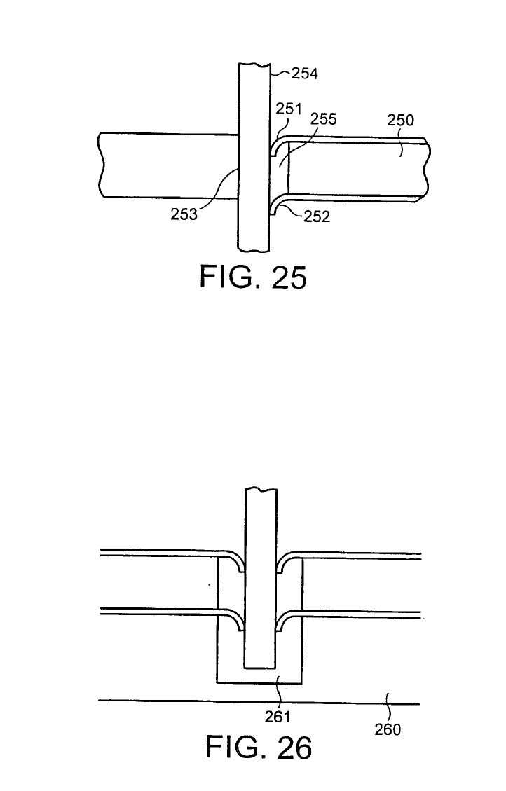

FIG. 25 shows a schematic cross-sectional view of a microclamp according to another embodiment of the present invention holding a micropart; and

FIG. 26 shows a schematic cross-sectional view of a microclamp according to yet another embodiment of the present invention holding a micropart.

With reference to FIGS. 3 and 4, a first embodiment of the microclamp of the present invention comprises a silicon substrate 12 defining a rectangular shaped through hole 20. A thin silicon nitride film 22 deposited on the upper surface of the silicon substrate includes portions 11, 15 which extend partially over the upper opening of the through hole 20 and serve as upper holding elements. A silicon nitride film 24 is also deposited on the lower surface of the silicon substrate and includes portions 13, 14 which extend partially over the lower opening of the through hole 20 which serve as lower holding elements. FIG. 4 shows a plan view of the upper side of the microclamp. The lower holding elements 13, 14 are hidden from view by the upper holding elements 11, 15, as a result of the spatial overlap of the upper and lower holding elements in the longitudinal direction of the hole. FIGS. 1 and 2 show the microclamp with a micropart 10 having a rectangular cross-section inserted and held in the hole 20 by means of the holding elements 11, 13, 14, 15 which flex when the micropart is inserted in the throughhole 20 and provide the force to hold the micropart in position in the direction between the sides of the throughhole 20 on which the holding elements are provided.

The thickness of the silicon nitride film will depend on the degree of the holding force that the holding elements are required to provide. A typical thickness would be in the range of 1 to 10 microns, but the thickness could be greater if a greater holding force is required. Thin films of materials other than silicon nitride can be used to form the holding elements provided they can fulfill the required function. Suitable materials include crystalline materials, non-crystalline materials, and glassy materials. Specific examples include silicon, silicon carbide and noncrystalline carbon. Glassy materials are preferred.

The substrate could alternatively be made from a glassy material, a metallic material or a plastics material.

A second embodiment of a microclamp according to the present invention is shown in FIGS. 5 and 6. FIG. 5 is a cross-section taken through line C-C in FIG. 6. This embodiment is identical to the first embodiment except that the longitudinal walls 53 of the silicon substrate 56 which define the throughhole 55 are imprecisely formed, and the silicon nitride films 52, 54 on the upper and lower surfaces of the silicon substrate 56 are patterned to provide a perimeter portion 51 which extends partially over the lower and upper openings of the throughhole 55 and a plurality of elongate portions 50 which extend from the perimeter portion 51 partially over the parts of the upper and lower openings, respectively, which remain uncovered by the perimeter portion 51.

Next, a method of producing a microclamp according to the present invention shall be described with reference to FIGS. 7 to 12.

As shown in FIG. 7, a silicon substrate 73 is coated with thin films 72, 74 of a silicon nitride (or other micromechanical material) on the front surface and on the back surface. Using standard photolithography a resist stencil 71 is produced on the silicon nitride film 72 on the front side of the substrate 73. The resist stencil 71 defines a hole 70 which extends down to the upper surface of the silicon nitride film 72. The shape of the hole 70 in the resist stencil is shown in plan view in FIG. 7(b).

Next, as shown in FIG. 8, the thin silicon nitride film 72 and the substrate material 73 are reactively etched using a plasma in accordance with the pattern defined by the hole of the resist stencil 71. For example, a plasma generated from a gas mixture of SF₆ and oxygen or a gas mixture of SF₆, CF₄ and oxygen can be used.

As shown in FIG. 9, the silicon nitride film 74 formed on the back side of the substrate 73 can be etched by changing the composition of the reactive gas used to form the plasma and using the same resist stencil as in FIG. 8. Alternatively, photolithography is done on the backside of the substrate, by providing a resist stencil (corresponding to that used on the front side) for etching a corresponding pattern in the lower silicon nitride film 74 from the backside. In this case, the transparency of silicon nitride is used to align the resist stencil on the back side, or special alignment features are etched at adjacent positions in the substrate prior to the stage shown in FIG. 7.

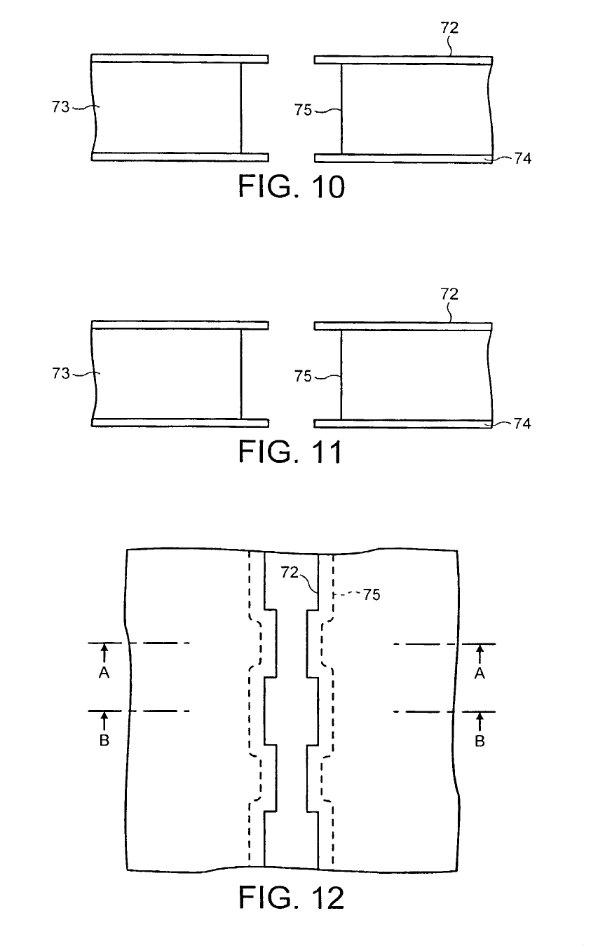

As shown in FIG. 10, portions of the substrate underlying the edge portions of the silicon nitride films 72, 74 defining the holes therein are undercut by using an isotropic liquid etchant that does not etch the silicon nitride films. Examples of suitable etchants are HF-based etchants and KOH-based etchants. This has the effect of enlarging the throughhole in the substrate such that portions of the silicon nitride films 72, 74 extend partially over the lower and upper openings of the through hole to provide the flexible holding elements. When a component is inserted into the hole it is only contacted by the portions of the silicon nitride extending over the upper and lower openings of the throughhole, and does not make contact with the silicon substrate material. In this way, the precision of the positioning of the component within the throughhole is determined primarily by the geometry of the silicon nitride holding elements, rather than by the geometry of the throughhole formed in the substrate.

A section of the resultant structure is shown in plan view in FIG. 12. The edge of the substrate 75 as etched by the isotropic liquid etchant is shown by the dotted line. FIGS. 10 and 11 are cross-sections taken through lines A-A and B-B in FIG. 12, respectively.

Applications of microclamps according to the present invention are described hereunder.

In FIG. 13, a multi-clamping structure 131 according to the present invention comprises two microclamps 134, 132 according to the present invention sharing a common a substrate. The multiclamping structure 131 is used to clamp a micropart 133 (such as an optical fibre) and a further micropart 135 comprising a microclamp 136 according to the present invention. The microclamp 136 of the micropart 135 is itself used to clamp an optical fibre 137.

In FIG. 14, another multi-clamping structure 141 according to the present invention is shown comprising two microclamps 142, 145 according to the present invention sharing a common substrate. The multiclamping structure 141 is shown holding two optical fibres 143, 144 in a parallel arrangement at an oblique angle to the substrate.

In FIG. 15, a multiclamping structure 151 according to the present invention is shown comprising two microclamps 152, 155 according to the present invention sharing a common substrate. The multi-clamping structure is shown holding two different microparts 153, 156.

In FIG. 16, a multi-clamping structure 161 according to the present invention is shown comprising three microclamps 167, 168, 169 according to the present invention sharing a common silicon substrate. An optic fibre 162 is positioned in the silicon substrate using conventional V-groove technology, and optical components 164, 165 and 166 are held by the microclamps 167, 168, 169. Using such a multiclamping structure, complete micro-optical systems such as dielectric stacked filters can be assembled at low cost.

In FIG. 17, there is shown a plan view of a microclamp according to the present invention for holding a micropart having a square cross-section. Upper and lower silicon nitride films formed on the upper and lower surfaces of a silicon substrate 171 include elongate holding elements 172, 173, 174, 175 which extend partially over the upper opening of the through hole 178. The lower holding elements extending partially over the lower opening of the throughhole 178 are hidden by the upper holding elements. The microclamp of FIG. 17 is shown in FIG. 18 holding a microcomponent 176 having a square cross-section. The symmetrical arrangement of the holding elements is particularly effective for holding the component in the required position.

In FIG. 19, there is shown a plan view of a microclamp according to the present invention for holding a micropart having a triangular cross-section. Upper and lower silicon nitride films formed on the upper and lower surfaces of a silicon substrate 191 include elongate holding elements 192 which extend partially over the upper opening of the through hole 198. The lower holding elements extending partially over the lower opening of the throughhole 198 are hidden by the upper holding elements. The microclamp of FIG. 19 is shown in FIG. 20 holding a microcomponent 193 having a square cross-section. The symmetrical arrangement of the holding elements is particularly effective for holding the component in the required position.

In FIG. 21, there is shown a plan view of a microclamp according to the present invention for holding a micropart having a circular cross-section. Upper and lower silicon nitride films formed on the upper and lower surfaces of a silicon substrate 211 include elongate holding elements 212 which extend partially over the upper opening of the through hole 218. The lower holding elements extending partially over the lower opening of the throughhole 218 are hidden by the upper holding elements. The microclamp of FIG. 21 is shown in FIG. 22 holding a microcomponent 222 having a circular cross-section. The symmetrical arrangement of the holding elements is particularly effective for holding the component in the required position.

In FIG. 23, optics fibres 236 and 237 are mounted using multiclamping structures 232, 233 according to the present invention each comprising a pair of microclamps according to the present invention sharing a common silicon substrate. These multiclamping structures 232, 233 are themselves mounted on another multiclamping structure 231 according to the present invention comprising three microclamps sharing a common substrate. A micro-optical component 235 is mounted on a further component 234, which is held by the third microclamp of the multiclamping structure 231. Using these multiclamping structures, complete optical systems such as sensors, multiplexers and Microsystems and microelectromechanical systems can be assembled.

In FIG. 24, a multiclamping structure according to the present invention is shown in plan view. This multiclamping structure comprises three microclamps according to the present invention sharing a common silicon substrate 241. An electrical connection 244 is provided on the substrate 241 to contact flexible holding element 243 which, when in use, in turn contacts a component held by the microclamp comprising flexible holding element 243. Other similar electrical connections 245, 246, 247, 248 are provided to other flexible holding elements. For example, deposited wire 248 contacts a flexible holding element in each of the three microclamps to provide, in use, an electrical connection to a plurality of components. In this way, a complete electrical system can be assembled at low cost.

In each of the applications described above, cooling fluid can be circulated efficiently by using the microchannels formed between the flexible holding elements. This provides the possibility for an increase in performance and improvement in density of computer and optoelectronic systems.

The microclamps discussed above all have flexible holding elements arranged on the upper and lower sides such that the component is held in the required position by means of the flexible holding elements only. This is advantageous since it means that the walls of the throughhole do not need to be precisely formed. However, the basic effect of the present invention can also be realised with a structure such as that shown in FIG. 25 in which the wall of the throughhole also play a role in holding the component in the desired position. Flexible holding elements 251, 252 and formed on both the upper and lower sides of a silicon substrate 250. In use, the micropart 254 is held in position by the wall of the throughhole on one side and by the flexible holding elements on the other side.

Furthermore, as shown in FIG. 26, the microclamp according to the present invention may further comprise a second substrate provided below the lower holding elements and having a corresponding hole formed therein. In the embodiment shown in FIG. 26, the hole is a blocked hole. Alternatively, it could be a throughhole which extends all the way through the second substrate. In such a case, further flexible holding elements could be provided secured to the lower surface of the second substrate and extending partially over the lower opening of the throughhole formed in the second substrate.

1. A microclamp for holding a micropart in a desired position comprising a substrate having an upper surface and a lower surface, and defining a throughhole extending from the upper surface to the lower surface to have an upper opening and a lower opening; at least one first holding element secured to the substrate and provided at the upper end of the throughhole; and at least one second holding element secured to the substrate and provided at the lower end of the throughhole; the first and second holding elements arranged such that when, in use, the micropart is inserted into the throughhole it is held at least partially by the first and second holding elements such that it is located in the desired position along at least one direction perpendicular to the longitudinal axis of the hole.

2. A microclamp for holding a micropart in a specific position according to claim 1, wherein the at least one first holding element is secured to the upper surface of the substrate and extends partially over the upper opening of the through hole; and the at least one second holding element is secured to the lower surface of the substrate and extends partially over the lower opening of the throughhole; each of the first and second holding elements being flexible in a direction parallel to the longitudinal axis of the hole.

3. A microclamp according to claim 2 wherein the first and second flexible holding elements spatially overlap in the longitudinal direction of the throughhole.

4. A microclamp according to claim 3 wherein a plurality of the first and second holding elements are provided around the edges of the substrate defining the upper and lower openings of the through hole, respectively.

5. A microclamp according to claim 4 wherein the plurality of first holding elements are provided symmetrically around the edge of the substrate defining the upper opening of the hole.

6. A microclamp according to claim 5 wherein the plurality of second holding elements are provided symmetrically around the edge of the substrate defining the lower opening of the hole, such that, in use, the micropart is held in a specific position by means of the holding elements only.

7. A microclamp according to claim 4 wherein the first holding elements are arranged on opposing sides of the upper opening of the throughhole.

8. A microclamp according to claim 7 wherein the second holding elements are arranged on opposing sides of the lower opening of the throughhole, such that, in use, the micropart is held in a specific position in the direction between the holding elements by means of the holding elements only.

9. A microclamp according to any preceding claim wherein the throughhole has a cross-section having a finite number of sides, and at least one first holding element is provided in respect of each side.

10. A microclamp according to claim 9 wherein at least one of the second holding elements is also provided in respect of each side.

11. A microclamp according to any of claims 2 to 10 wherein the first and second holding elements are thin films.

12. A microclamp according to claim 11 wherein the first and second holding elements are made from a noncrystalline material.

13. A microclamp according to claim 11 wherein the first and second holding elements are made of a glassy material.

14. A microclamp according to claim 11 wherein the first and second holding elements are made from a material selected from the group consisting of silicon, silicon nitride, silicon carbide, or noncrystalline carbon.

15. A microclamp according to any preceding claim wherein the substrate is made of a glassy material, a plastic material or a metallic material.

16. A microclamp according to any preceding claim wherein the substrate is a silicon substrate.

17. A microclamp according to any preceding claim adapted to hold a micropart having a rectangular cross-section, a triangular cross-section, a polyhedral cross-section, or a cylindrical cross-section.

18. A microclamp according to any preceding claim adapted to hold an optical fibre.

19. A microclamp according to any preceding claim wherein at least one of the first and second holding elements comprises an electrical conductor extending to a portion of the respective holding element that, in use, contacts the micropart to thereby provide an electrical connection between the respective holding element and the micropart.

20. A microclamp according to any preceding claim wherein the first and second holding elements are positioned such that, in use, there is sufficient space between the micropart and the substrate to allow the passage of a fluid through the throughhole.

21. A composite structure comprising a microclamp according to any preceding claim and a micropart inserted and held in the throughhole.

22. A composite structure according to claim 21 wherein the micropart comprises a microclamp according to any of claims 1 to 20.

23. A composite structure comprising a first microclamp according to any of claims 1 to 20, a second microclamp according to any of claims 1 to 20, and a micropart inserted and held in both the throughholes of the first and second microclamps.

24. A composite structure according to any of claims 21 to 23 wherein the section of the micropart held within the through hole has a parallel sided cross-sectional geometry.

25. A composite structure according to any of claims 21 to 23 wherein the section of the micropart held within the through hole has a rectangular cross-section, a triangular cross-section, a polyhedral cross-section, or a cylindrical cross-section.

26. A composite structure according to any of claims 21 to 23 wherein the micropart is an optical fibre.

27. A composite structure according to any of claims 21 to 26 wherein at least one of the first and second holding elements comprises an electrical conductor extending to a portion of the respective holding element contacting the micropart to thereby provide an electrical connection between the respective holding element and the micropart.

28. A composite structure according to any of claims 21 to 27 wherein there is sufficient space between the micropart and the substrate to allow the passage of a fluid through the throughhole.

29. A method of controlling the temperature of the micropart according to claim 28 comprising passing a fluid through the throughhole in which the micropart is held.

30. A multi-clamping structure for holding a plurality of microparts comprising a first microclamp according to any of claims 1 to 20, and a second microclamp according to any of claims 1 to 20, wherein the first and second microclamps are connected together.

31. A multi-clamping structure according to claim 30 wherein the first and second microclamps are connected together such that the substrates of each lie in a common plane.

32. A multi-clamping structure according to claim 30 or claim 31 wherein the first and second microclamps are connected together such that the through holes of the first and second microclamps have substantially parallel longitudinal axes.

33. A multi-clamping structure according to any of claims 30 to 32 wherein the first and second microclamps share a common substrate.

34. A method of producing a microclamp comprising the steps of: providing a substrate having an upper surface and a lower surface; forming a first layer of a micromechanically flexible material on the upper surface of the substrate; forming a second layer of a micromechanically flexible material on the lower surface of the substrate; selectively removing a portion of the first layer of micromechanically flexible material, the substrate, and the second layer of micromechanically flexible material to form therein first, second and third throughholes, respectively, the first, second and third throughholes lying on a common axis; and then further removing a portion of the substrate lying between the first and second layers of micromechanically flexible material to increase the size of the second throughhole formed in the substrate, and thereby leave one or more portions of the first and second layers of micromechanically flexible material extending partially over the upper and lower openings of the enlarged second throughhole, respectively, to serve as flexible holding elements.

35. A microclamp for holding a micropart comprising a substrate having an upper surface and a lower surface, and defining a throughhole extending from the upper surface to the lower surface to have an upper opening and a lower opening; at least one first flexible holding element formed on the upper surface of the substrate and extending partially over the upper opening of the throughhole; and at least one second flexible holding element formed on the lower surface and extending partially over the lower opening of the throughhole; each flexible holding element being flexible in a direction parallel to the longitudinal axis of the hole.
